(19) United States
(12) Patent Application Publication
(10) Pub. No.: US 2025/0150916 A1
(43) Pub. Date: May 8, 2025

(54) METHODS AND APPARATUS FOR UE REDIRECTION BASED ON ENERGY IN A WIRELESS COMMUNICATION SYSTEM

(71) Applicant: Samsung Electronics Co., Ltd., Suwon-si (KR)

(72) Inventors: Mahmoud WATFA, Staines (GB); Chadi KHIRALLAH, Staines (GB)

(21) Appl. No.: 18/934,541

(22) Filed: Nov. 1, 2024

(30) Foreign Application Priority Data
Nov. 3, 2023 (GB) 2316928.7
Sep. 12, 2024 (GB) 2413465.2

(51) Int. Cl. H04W 36/08; H04W 8/20; H04W 36/16

(52) U.S. Cl. CPC H04W 36/08; H04W 8/20; H04W 36/165

(57) ABSTRACT

The disclosure relates to a 5G or 6G communication system for supporting a higher data transmission rate. A method for energy saving in a network is provided. The method includes determining, based on energy information associated with a first network node, that the capacity of the first network node should be reduced, based on the determining, selecting a second network node, and redirecting a UE from the first network node to the second network node.

### CROSS-REFERENCE TO RELATED APPLICATION(S)

This application is based on and claims priority under 35 U.S.C. § 119 (a) of a United Kingdom patent application number 2316928.7, filed on Nov. 3, 2023, in the United Kingdom Intellectual Property Office, and of a United Kingdom patent application number 2413465.2, filed on Sep. 12, 2024, in the United Kingdom Intellectual Property Office, the disclosure of each of which is incorporated by reference herein in its entirety.

### BACKGROUND

### 1. Field

The disclosure relates to one or more techniques for redirecting a user equipment (UE) based on energy. More particularly, the disclosure relates to techniques in a 3rd generation partnership project (3GPP) 5^{th} generation (5G) new radio (NR) network.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The present disclosure relates to wireless communication systems and, more specifically, the present disclosure relates to UE redirection in a wireless communication system.

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

The present invention is defined in the independent claims. Advantageous features are defined in the dependent claims. Embodiments or examples disclosed in the description and/or figures falling outside the scope of the claims are to be understood as examples useful for understanding the present invention.

In accordance with an aspect of the disclosure, a method performed by an access and mobility management function (AMF) entity in a communication system, the method comprising: determining whether to reduce a capacity of the AMF based on energy related information of the AMF; in case that the capacity of the AMF is determined to be reduced, determining whether to redirect at least one user equipment (UE) to another AMF, based on subscription information of the at least one UE for the AMF; and in case that the at least one UE is determined to redirect to the another AMF, triggering a procedure to redirect the at least one UE to the another AMF.

In accordance with an aspect of the disclosure, a method performed by a next generation-radio access network (NG-RAN) in a communication system, the method comprising: receiving, from an access and mobility management function (AMF) entity of the NG-RAN, a reroute non access stratum (NAS) request message for redirecting at least one user equipment (UE) from a first AMF entity to a second AMF entity, the reroute NAS request message including a NAS message received from the at least one UE; based on receiving the reroute NAS request message, selecting the second AMF entity as an AMF for a redirection; transmitting, to the second AMF entity, the NAS message.

In accordance with an aspect of the disclosure, an access and mobility management function (AMF) entity in a communication system, the AMF entity comprising: a transceiver; and a controller coupled with the transceiver, the controller configured to: determine whether to reduce a capacity of the AMF based on energy related information of the AMF; in case that the capacity of the AMF is determined to be reduced, determine whether to redirect at least one user equipment (UE) to another AMF, based on subscription information of the at least one UE for the AMF; and in case that the at least one UE is determined to redirect to the another AMF, trigger a procedure to redirect the at least one UE to the another AMF.

In accordance with an aspect of the disclosure, a next generation-radio access network (NG-RAN) in a communication system, the NG-RAN comprising: a transceiver; and a controller coupled with the transceiver, the controller configured to: receive, from an access and mobility management function (AMF) entity of the NG-RAN, a reroute non access stratum (NAS) request message for redirecting at least one user equipment (UE) from a first AMF entity to a second AMF entity, the reroute NAS request message including a NAS message received from the at least one UE; based on receiving the reroute NAS request message, select the second AMF entity as an AMF for a redirection; and transmit, to the second AMF entity, the NAS message.

Other aspects, advantages, and salient features of the disclosure will become apparent to those skilled in the art from the following detailed description, which, taken in conjunction with the annexed drawings, discloses various embodiments of the disclosure.

According to an embodiment of the disclosure, a wireless communication can be performed efficiently. Especially, a UE redirection can be performed efficiently.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a method for energy saving in a network according to an embodiment of the disclosure; and

FIG. 2 is a block diagram of a network entity that may be used according to an embodiment of the disclosure.

Throughout the drawings, it should be noted that like reference numbers are used to depict the same or similar elements, features, and structures.

### DETAILED DESCRIPTION

Various acronyms, abbreviations and definitions used in the disclosure are defined at the end of this description.

The following documents may be referenced in the disclosure:
[1] 3GPP SP-231192: New SID on 5GS enhancement for energy efficiency and energy saving
[2] 3GPP TS 24.501 V18.4.0

### Study on Energy Efficiency

3GPP SA2 is currently performing a study on energy efficiency for which the scope and objectives are defined in [1].

The following work task (WT) is from [1] and it describes some of the objectives of the study.
WT #3. Study 5GS enhancements (e.g., energy usage adjustment for NF from Core Network (CN) aspect, energy saving related decision making, NF selection leveraging NF energy states) for network energy saving including 5GC (NFs) and NG-RAN interactions, analytics, or the like. Impacts on the UE are not ruled out e. g., for scenarios specified in TR 22.882 by SA1 EnergyServ.

As can be seen from the above, one of the aspects that will be studied is related to energy savings.

The above information is presented as background information only to assist with an understanding of the disclosure. No determination has been made, and no assertion is made, as to whether any of the above might be applicable as prior art with regard to the disclosure.

The following description with reference to the accompanying drawings is provided to assist in a comprehensive understanding various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The same or similar components may be designated by the same or similar reference numerals, although they may be illustrated in different drawings.

Detailed descriptions of techniques, structures, functions, operations or processes known in the art may be omitted for clarity and conciseness, and to avoid obscuring the subject matter of the disclosure.

The terms and words used herein are not limited to the bibliographical or standard meanings, but, are merely used to enable a clear and consistent understanding of the disclosure.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

The skilled person will appreciate that the techniques described herein may be used in any suitable order and/or combination.

Certain examples of the disclosure provide one or more techniques for redirecting UEs based on energy, for example in a 3GPP 5G NR network. However, the skilled person will appreciate that the disclosure is not limited to these examples, and may be applied in any suitable system or standard, for example one or more existing and/or future generation wireless communication systems or standards, including any existing or future releases of the same standards specification, for example 3GPP 5G, 5G-advanced or 6^{th} generation (6G).

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network.

A particular network entity may be implemented as a network element on a dedicated hardware, as a software instance running on a dedicated hardware, and/or as a virtualised function instantiated on an appropriate platform, e.g., on a cloud infrastructure.

The skilled person will appreciate that the disclosure is not limited to the specific examples disclosed herein. For example:

The techniques disclosed herein are not limited to 3GPP 5G.

One or more entities in the examples disclosed herein may be replaced with one or more alternative entities performing equivalent or corresponding functions, processes or operations.

One or more of the messages in the examples disclosed herein may be replaced with one or more alternative messages, signals or other type of information carriers that communicate equivalent or corresponding information.

One or more further elements or entities may be added to the examples disclosed herein.

One or more non-essential elements or entities may be omitted in certain examples.

The functions, processes or operations of a particular entity in one example may be divided between two or more separate entities in an alternative example.

The functions, processes or operations of two or more separate entities in one example may be performed by a single entity in an alternative example.

Information carried by a particular message in one example may be carried by two or more separate messages in an alternative example.

Information carried by two or more separate messages in one example may be carried by a single message in an alternative example.

The order in which operations are performed and/or the order in which messages are transmitted may be modified, if possible, in alternative examples.

Certain examples of the disclosure may be provided in the form of an apparatus/device/network entity configured to perform one or more defined network functions and/or a method therefor. Certain examples of the disclosure may be provided in the form of a system (e.g., network or wireless communication system) comprising one or more such apparatuses/devices/network entities, and/or a method therefor.

There are no current solutions which have been proposed for redirecting the UE to a target network, or a target network function (NF), when a source network or a source NF wants to reduce its capacity due to energy.

Certain examples of the disclosure provide one or more techniques for redirecting UEs based on energy.

Certain examples of the disclosure provide a method for energy saving in a network, the method comprising: determining, based on energy information associated with a first network node, that the capacity of the first network node should be reduced; based on the determining, selecting a second network node; and redirecting a UE from the first network node to the second network node.

In an embodiment of the disclosure, the energy information may comprise information based on an energy usage level of the first network node.

In an embodiment of the disclosure, the determining is based on a comparison between the energy usage level and a threshold.

In an embodiment of the disclosure, the first network node may be a first access and mobility management function (AMF), and the second network node may be a second AMF different from the first AMF; the first network node may be a first session management function (SMF), and the second network node may be a second SMF different from the first SMF; or the first network node may be a first user plane function (UPF), and the second network node may be a second UPF different from the first UPF.

In an embodiment of the disclosure, the first network node may be a node of a first core network (CN), and the second network node is a node of a second CN different from the first CN.

In an embodiment of the disclosure, the determining, selecting and/or redirecting may be performed by one or more of: the first network node, a third network node different from the first and second network nodes, a radio access network (RAN) node, a mobility management entity (MME), an access and mobility management function (AMF), and a session management function (SMF).

In an embodiment of the disclosure, the redirecting may be performed based on non access stratum (NAS) messages.

In an embodiment of the disclosure, the redirected UE may be selected based on UE subscription information.

In an embodiment of the disclosure, the selecting may be performed based on energy information associated with the second network node.

In an embodiment of the disclosure, the method may further comprise receiving, from the UE, an indication that the UE supports redirection based on energy.

In an embodiment of the disclosure, the method may further comprise transmitting, to the UE, an indication that the network supports redirection based on energy.

Certain examples of the disclosure provide a network node configured to perform a method according to any example, aspect, embodiment and/or claim disclosed herein.

Certain examples of the disclosure provide a network (or wireless communication system) comprising a network node according to any example, aspect, embodiment and/or claim disclosed herein.

Certain examples of the disclosure provide a computer program comprising instructions which, when the program is executed by a computer or processor, cause the computer or processor to carry out a method according to any example, aspect, embodiment and/or claim disclosed herein.

Certain examples of the disclosure provide a computer or processor-readable data carrier having stored thereon a computer program according to any example, aspect, embodiment and/or claim disclosed herein.

Various examples will now be described in more detail.

In the following sections are described (1) actions to redirect UEs across AMFs using NAS messages, (2) actions to redirect UEs across AMFs via interactions with the RAN, (3) actions to redirect UEs across CN due to energy, (4) actions to redirect UEs across SMFs due to energy, and (5) RAN selection of AMF/MME considering energy.

The skilled person will appreciate that the techniques described in these sections may be used in any suitable order and/or combination.

The following section describes the network behaviour when it determines to reduce the capacity on certain NFs and how it can do so by moving UEs to other NFs or target networks for the purpose of reducing capacity and hence energy. As such, the actions for the NFs are due to energy constraints.

### 1. Actions to Redirect UEs Across Access and Mobility Management Functions (AMFs) Using Non Access Stratum (NAS) Messages

In an embodiment of the disclosure, the AMF may determine to reduce its capacity (or reduce the number of UEs that it serves) due to energy constraints. For example, the AMF may make this determination based on local energy usage levels (e.g., exceeding a certain threshold) and/or based on operation and maintenance procedures, and/or based on an explicit indication from another NF.

When this occurs, the AMF may be configured to redirect at least one UE to another AMF, where the determination of which UE to redirect may be based on subscription information. As such, new subscription information may be defined such that it indicates if a UE may be subject to redirection based on energy levels in the current NF that serves the UE, where this NF may be an AMF, Session Management Function (SMF), or any other suitable NFs. As such, the subscription information may be sent to at least the AMF, SMF, or any other suitable NFs.

Once an AMF determines that a UE should be redirected, for example based on any of techniques disclosed herein, the AMF may use any suitable redirection mechanism towards the UE, for example as follows:

The AMF sends the configuration update command (CUC) message and includes the necessary parameters which will lead to the UE to register again from idle mode and not include the 5G-Globally unique temporary identifier (GUTI) during the registration procedure, which will then lead to not selecting this same AMF as there is not temporary ID (i.e., 5G-GUTI) to point to this particular AMF.

For example, the AMF should shall indicate “registration requested” in the registration requested bit of the configuration update indication information element (IE) which is in the CUC message. In certain examples, the message should not contain any other parameter.

When the UE performs a registration again, the UE NAS shall not provide the lower layers with the 5G-Short(S)-temporary mobile subscriber identity (TMSI) or the registered globally unique AMF ID (GUAMI).

In an embodiment of the disclosure, the AMF should reject a NAS message from the UE and include a suitable cause value that indicates the need to re-register due to energy constraints in the network.

The UE should then register again the UE NAS shall not provide the lower layers with the 5G-S-TMSI or the registered GUAMI.

The skilled person will appreciate that the techniques described herein can be applied to UEs that are in connected mode, and/or that are sending a NAS message either from connected mode or from idle mode, and/or from 5G mobile management (5GMM)-CONNECTED mode with radio resource control (RRC) inactive indication.

2. Actions to Redirect UEs Across AMFs Via Interactions with the RAN

In an embodiment of the disclosure, the AMF may determine to reduce its capacity (and/or reduce the number of UEs that it serves) due to energy constraints. For example, the AMF may do this determination based on local energy usage levels (e.g., exceeding a certain threshold) and/or based on operation and maintenance procedures, and/or based on an explicit indication form another NF.

When this occurs, the AMF may be configured to redirect at least one UE to another AMF, where the determination of which UE to redirect may be based on subscription information. As such, new subscription information may be defined such that it indicates if a UE may be subject to redirection based on energy levels in the current NF that serves the UE, where this NF may be an AMF, SMF, or any other suitable NFs. As such, the subscription information may be sent to at least the AMF, SMF, or any other suitable NFs.

Once an AMF determines that a UE should be redirected, for example based on any of the techniques disclosed herein, the AMF may use any suitable redirection mechanism towards the UE, for example as follows:

The AMF should trigger the re-route procedure on the NG-AP interface (see 3GPP TS 38.413) by sending the REROUTE NAS REQUEST to the NG-RAN. The AMF should include the NAS message which was received from the UE. The AMF may indicate that the reason is due to energy constraints.

The NG-RAN should then select another AMF and route the NAS message to the new AMF, optionally based on the indication of energy constraints from the source AMF.

When re-routing the NAS message to another AMF, the NG-RAN may indicate that this is a due to a re-route as a result of energy constraints in a source AMF.

The skilled person will appreciate that the techniques described herein can be applied to S1 mode, i.e., to evolved packet system (EPS). For example, the same reroute mechanism can be used by mobility management entity (MME) based on a similar S1 application protocol (S1AP) message which is defined in 3GPP TS 36.413.

As such, the MME may also reroute a NAS message to a target MME due to energy constraints. Therefore, various techniques disclosed herein can also be applied to EPS where similar or equivalent messages and/or IEs can be used.

### 3. Actions to Redirect UEs Across CN Due to Energy

In an embodiment of the disclosure, the AMF may determine to reduce its capacity (and/or reduce the number of UEs that it serves) due to energy constraints. For example, the AMF may make this determination based on local energy usage levels (e.g., exceeding a certain threshold) and/or based on operation and maintenance procedures, and/or based on an explicit indication form another NF.

When this occurs, the AMF may be configured to redirect at least one UE to another core network, for example to evolved packet core (EPC). The AMF may use any suitable mechanism to redirect the UE to EPC, where the trigger to do so may be based on energy usage levels in 5GS, and the AMF being configured to redirect the UE to EPC where the AMF may be aware that the EPC's energy level usage is acceptable. How the AMF makes this determination may be out of scope.

In an embodiment of the disclosure, the AMF may redirect a UE to EPC based on indication that the UE supports energy efficiency or based on the UE supporting cellular Internet of things (CIoT) optimizations.

The UE may indicate in an existing IE or a new IE that it supports energy efficiency or it supports redirection to a target CN based on energy efficiency.

The network may also inform the UE that it supports redirecting UEs to target CN based on energy efficiency. The network may do so for UEs for which there is subscription information to redirect the UEs based on energy considerations. As such, any suitable subscription information may be defined for this purpose, where this may be provided for example to the AMF, for example from the Unified Data Management (UDM), and for example based on which the AMF may determine which UE to redirect to EPC.

In an embodiment of the disclosure, to perform the actual redirection, the AMF may behave as follows:

When the UE sends any NAS message, the AMF may respond with a NAS reject message and include the 5GMM cause value #31 Redirection to EPC required, or a new IE may be used to indicate redirection to EPC due to energy constraints.

The NAS message from the UE may be any suitable NAS message, for example registration request, service request, or control plane service request.

In EPC, the UE may use attach request, tracking area update request message, service request, or control plane service request.

The AMF may redirect the UE, due to energy constraints, by using registration reject or service reject, and by including the 5GMM cause value #31 redirection to EPC required, or a new cause value.

In EPC, the MME may use attach reject, tracking area update reject, or service reject.

The AMF may also send a deregistration request message to the UE and include the 5GMM cause value #31 Redirection to EPC required, or a new cause value. In EPC, the MME may use detach request for the same purpose.

Although some of the messages above are re-used, the trigger for doing so is now energy related. As such, the AMF may behave as described above when it needs to reduce energy in the network (or the AMF).

The skilled person will appreciate that the techniques described herein can be applied to EPS in which the MME may use similar methods (with appropriate or corresponding or equivalent NAS messages) in order to redirect a UE to 5GC. The same technique can also be used for a new system, for example for 6G such that a 6G NF can redirect the UE to 5G or 4th Generation (4G).

### 4. Actions to Redirect UEs Across SMFs Due to Energy

Redirecting a UE from one SMF may also mean that the SMF will stop serving the UE.

The SMF may determine to reduce its capacity (and/or reduce the number of UEs that it serves) due to energy constraints. For example, the SMF may make this determination based on local energy usage levels (e.g., exceeding a certain threshold) and/or based on operation and maintenance procedures, and/or based on an explicit indication form anther NF.

The UE may indicate in an existing IE or a new IE that it supports energy efficiency or it supports redirection to a target CN based on energy efficiency.

The network may also inform the UE that it supports redirecting UEs to target CN based on energy efficiency. The network may do so for UEs for which there is subscription information to redirect the UEs based on energy considerations. As such, any suitable subscription information may be defined for this purpose, where this may be provided for example to the SMF, for example from the UDM, for example based on which the SMF may determine which UE to stop serving.

When this occurs, the SMF may be configured to redirect at least one UE to another SMF, and/or may determine to stop serving the UE in question, for which the SMF may behave for example as follows:

The SMF may release the protocol data unit (PDU) session (and send PDU session release command message) and indicate any existing 5G session management (5GSM) cause value, or a new value may be defined to indicate that the reason is due to energy.

The SMF may send the PDU session modification command message and indicate a new 5GSM cause value to indicate that the reason is due to energy, or the SMF may use an existing #39-reactivation requested.

In an embodiment of the disclosure, when the UE receives any of the messages listed above, the UE may behave as follows:

The UE may attempt to establish another PDU session and indicate that the establishment is due to energy, i.e., that the session is being used to replace another session as a result of energy constraints. The UE may provide this indication in the NAS message that is a mobility management message (e.g., the Uplink (UL) NAS TRANSPORT message), and/or any session management message (e.g., PDU session establishment request message), and/or any suitable IE may be used to provide this indication from the UE.

The SMF may inform the AMF that it needs to reduce capacity due to energy. The AMF may be configured to reduce the number of UEs which use a particular SMF, for example based on local policies, and/or based on indication from the SMF, and/or based on operations, administration and maintenance (OAM).

In an embodiment of the disclosure, to reduce the number of UEs which use an SMF, the AMF should update the allowed network slice selection assistance information (NSSAI) for each and every UE that was provided with a Single NSSAI (S-NSSAI) that is served by the SMF in question. The AMF may send a new allowed NSSAI (e.g., using any NAS message) such that the S-NSSAI which corresponds to the SMF (that is constrained with energy) is not part of the updated (or new) allowed NSSAI. The AMF may indicate that the S-NSSAI is rejected or simply not include the S-NSSAI in the allowed NSSAI. The AMF may indicate that a slice is not available (e.g., temporarily) due to energy constraints. In certain examples, the AMF may do so for particular UEs that support this, for example based on capabilities which may be exchanged between the UE and the network as described above. In certain examples, the AMF may do so for UE that are subject to this, for example based on subscription information as described above.

In an embodiment of the disclosure, if the SMF determines that a user plane function (UPF) is having energy constraints (e.g., the UPF cannot serve more UEs and/or existing UEs), the SMF may take the following actions:

The SMF may release the PDU session for at least one UE where the PDU session is being served by the UPF in question.

The SMF may indicate that resources are not available in the UPF.

In an embodiment of the disclosure, the AMF may reject a request for user plane establishment towards a UPF (e.g., based on indication from the SMF to the AMF) due to energy constraints. The AMF may indicate that resources are not available, where a new cause value may be used or existing cause values may be used e.g., #67—Insufficient resources for specific slice and data network (DN), or #92—Insufficient user-plane resources for the PDU session, or any other suitable cause value. The AMF or SMF may use the new cause value, or existing cause values, in any NAS message. The NAS message may be new or existing.

5. RAN Selection of AMF/MME should Now Consider Energy

In an embodiment of the disclosure, the RAN (e.g., NG-RAN or RAN in evolved UMTS terrestrial RAN (E-UTRAN)) may be configured to select a CN node based on energy levels or energy capacity (and/or capacity which may translate to energy) in the CN. The RAN may be configured with the information of each CN node's energy level or usage.

The RAN may receive a NAS message from a UE, for example during RRC establishment procedure, in which the RAN needs to send the NAS message to a selected CN. In certain examples, the selection of a CN node by the RAN should consider the energy levels of a CN node. For example, multiple AMFs and/or multiple MMEs may serve an area and the RAN needs to choose one AMF or one MME. The RAN should make the selection by taking into account the energy levels of the CN. For example, if one AMF or MME is having high energy levels, then the RAN may avoid selecting it and it may select another CN node. The RAN may be configured to select a CN node such that the energy level usage across the CN nodes is (as much as possible) balanced. The RAN may be informed about the energy levels in the CN nodes using any suitable mechanism, for example based on a message from the CN to the RAN (where the message may be new or existing), and/or based on configurations in the RAN, and/or based on operation and maintenance.

In an embodiment of the disclosure, the RAN may take other factors into account while selecting a CN node, for example load levels, but the RAN should also consider energy levels of the CN nodes as described herein.

In an embodiment of the disclosure, the RAN may be informed by a CN node (using new and/or existing messages) to stop or to resume selection of the CN node in question for reasons due to energy.

In an embodiment of the disclosure, the RAN should not select a CN node which has informed the RAN of high energy levels or which have informed the RAN that the CN node should not be selected optionally due to energy constraints.

In an embodiment of the disclosure, the RAN can select a CN node which has informed the RAN of low energy levels or which have informed the RAN that the CN node can be selected optionally due to energy constraints being acceptable.

One of ordinary skill in the art will appreciate that the various techniques disclosed herein may be applied to any suitable system, such as 5G, 4G, 6G, or the like. The NAS messages in 5G or 4G may have different names, or the IEs may be named differently, however the proposals may still be applied.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

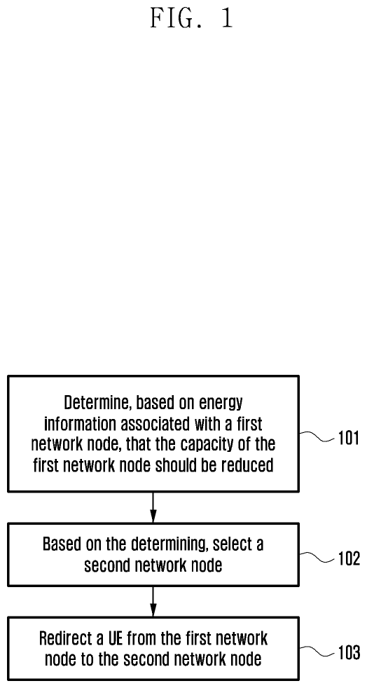

FIG. 1 illustrates a method for energy saving in a network according to an embodiment of the disclosure.

Referring to FIG. 1, in a first operation 101, it is determined, based on energy information associated with a first network node (e.g., a first AMF, SMF or UPF, and/or a node of a first CN), that the capacity of the first network node should be reduced. For example, the energy information may comprise information based on an energy usage level of the first network node. In certain examples, the determining may be based on a comparison between the energy usage level and a threshold.

In a second operation 102, based on the determining, a second network node (e.g., a second AMF, SMF or UPF, and/or a node of a second CN) is selected. For example, the selecting may be performed based on energy information associated with the second network node.

In a third operation 103, a UE is redirected from the first network node to the second network node. For example, the redirected UE may be selected based on UE subscription information. In certain examples, the redirecting may be performed based on NAS messages.

The various operations 101, 102, 103 may be performed by any suitable nodes and/or entities, for example the first network node and/or another network node/entity (e.g., a third network node, RAN, MME, AMF, SMF). In various examples, the operations 101, 102, and 103 may be performed by the same node/entity or different nodes/entities.

Although not shown in FIG. 1, in certain examples the method may further comprise receiving, from the UE, an indication that the UE supports redirection based on energy, and/or transmitting, to the UE, an indication that the network supports redirection based on energy.

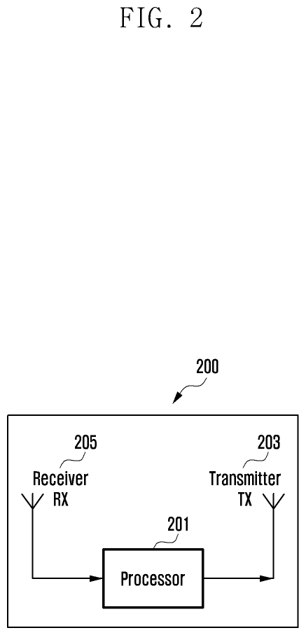

FIG. 2 is a block diagram of a network entity that may be used according to an embodiment of the disclosure. The skilled person will appreciate that a network entity may be implemented, for example, as a network element on a dedicated hardware, as a software instance running on a dedicated hardware, and/or as a virtualised function instantiated on an appropriate platform, e.g., on a cloud infrastructure.

Referring to FIG. 2, the entity 200 comprises a processor (or controller) 201, a transmitter 203 and a receiver 205. The receiver 205 is configured for receiving one or more messages from one or more other network entities, for example as described above. The transmitter 203 is configured for transmitting one or more messages to one or more other network entities, for example as described above. The processor 201 is configured for performing one or more operations, for example according to the operations as described above.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the disclosure may be implemented in the form of hardware, software or any combination of hardware and software. Any such software may be stored in the form of volatile or non-volatile storage, for example a storage device like read only memory (ROM), whether erasable or rewritable or not, or in the form of memory, such as, for example, random access memory (RAM), memory chips, device or integrated circuits or on an optically or magnetically readable medium, such as, for example, a compact disc (CD), digital versatile disc (DVD), magnetic disk or magnetic tape or the like.

It will be appreciated that the storage devices and storage media are embodiments of machine-readable storage that are suitable for storing a program or programs comprising instructions that, when executed, implement certain examples of the disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and detail may be made therein without departing from the spirit and scope of the disclosure as defined by the appended claims and their equivalents.

What is claimed is:

1. A method performed by a network entity in a communication system, the method comprising:
determining whether to reduce a capacity of an access and mobility management function (AMF) entity based on energy related information of the AMF entity;
in case that the capacity of the AMF entity is determined to be reduced, determining whether to redirect at least one user equipment (UE) to another AMF entity, based on subscription information of the at least one UE for the AMF entity; and
in case that the at least one UE is determined to redirect to the another AMF entity, triggering a procedure to redirect the at least one UE to the another AMF entity.

2. The method of claim 1,
wherein the triggering is further configured to:
transmitting, to a next generation-radio access network (NG-RAN), a reroute non access stratum (NAS) request message, and
wherein the reroute NAS request message includes a NAS message received from the at least one UE redirected to the another AMF entity.

3. The method of claim 2, further comprising:
indicating, via the reroute NAS request message, the procedure to redirect the at least one UE is based on energy constraint of the AMF entity.

4. The method of claim 1, wherein the energy related information of the AMF entity includes energy consumption level.

5. A method performed by a next generation-radio access network (NG-RAN) in a communication system, the method comprising:
receiving, from an access and mobility management function (AMF) entity of the NG-RAN, a reroute non access stratum (NAS) request message for redirecting at least one user equipment (UE) from a first AMF entity to a second AMF entity, the reroute NAS request message including a NAS message received from the at least one UE;
based on receiving the reroute NAS request message, selecting the second AMF entity as an AMF entity for a redirection; and
transmitting, to the second AMF entity, the NAS message.

6. The method of claim 5, wherein the transmitting is further configured to:
indicating, the redirection is based on energy constraints of the first AMF entity.

7. The method of claim 5, wherein the redirection is determined based on energy related information of the first AMF entity.

8. A network entity in a communication system, the network entity comprising:
a transceiver; and
a controller coupled with the transceiver, the controller configured to:
determine whether to reduce a capacity of an access and mobility management function (AMF) entity based on energy related information of the AMF entity,
in case that the capacity of the AMF entity is determined to be reduced, determine whether to redirect at least one user equipment (UE) to another AMF entity, based on subscription information of the at least one UE for the AMF entity, and
in case that the at least one UE is determined to redirect to the another AMF entity, trigger a procedure to redirect the at least one UE to the another AMF entity.

9. The network entity of claim 8,
wherein the controller is further configured to:
transmit, to a next generation-radio access network (NG-RAN), a reroute non access stratum (NAS) request message, and
wherein the reroute NAS request message includes a NAS message received from the at least one UE redirected to the another AMF entity.

10. The network entity of claim 9, wherein the controller is further configured to:
indicate, via the reroute NAS request message, the procedure to redirect the at least one UE is based on energy constraint of the AMF entity.

11. The network entity of claim 8, wherein the energy related information of the AMF entity includes energy consumption level.

12. A next generation-radio access network (NG-RAN) in a communication system, the NG-RAN comprising:
a transceiver; and
a controller coupled with the transceiver, the controller configured to:
receive, from an access and mobility management function (AMF) entity of the NG-RAN, a reroute non access stratum (NAS) request message for redirecting at least one user equipment (UE) from a first AMF entity to a second AMF entity, the reroute NAS request message including a NAS message received from the at least one UE,
based on receiving the reroute NAS request message, select the second AMF entity as an AMF entity for a redirection, and
transmit, to the second AMF entity, the NAS message.

13. The NG-RAN of claim 12, wherein the controller is further configured to: indicate, the redirection is based on energy constraints of the first AMF entity.

14. The NG-RAN of claim 12, wherein the redirection is determined based on energy related information of the first AMF entity.
